(19) United States
(12) Patent Application Publication
(10) Pub. No.: US 2020/0012675 A1
(43) Pub. Date: Jan. 9, 2020

(54) METHOD AND APPARATUS FOR PROCESSING VOICE REQUEST

(71) Applicant: Baidu Online Network Technology (Beijing) Co., Ltd., Beijing (CN)

(72) Inventors: Shiquan Ye, Beijing (CN); Jue Huang, Beijing (CN); Hong Su, Beijing (CN); Xing Luo, Beijing (CN); Xiajun Luo, Beijing (CN); Di Peng, Beijing (CN)

(21) Appl. No.: 16/447,646

(22) Filed: Jun. 20, 2019

(30) Foreign Application Priority Data
Jul. 3, 2018 (CN) 201810720401.2

(51) Int. Cl. G06F 16/435; G10L 15/22; G10L 15/18; G06F 16/9535; G06F 16/955; G06F 16/438

(52) U.S. Cl. CPC G06F 16/435; G10L 15/22; G10L 15/1815; G10L 2015/223; G06F 16/9558; G06F 16/438; G06F 16/9535

(57) ABSTRACT

A method and an apparatus for processing a voice request are provided. The method includes: searching, in response to determining that a target multimedia resource requested to be played in a voice request is not included in a preset multimedia resource library, for the target multimedia resource in a resource library other than the multimedia resource library; and sending a link address of the found target multimedia resource ant an instruction for playing the target multimedia resource to a smart voice device. The coverage of the content of a voice service is expanded, thereby improving the efficiency of the voice service.

### CROSS-REFERENCE TO RELATED APPLICATIONS

This application claims priority to Chinese Patent Application No. 201810720401.2, filed on Jul. 3, 2018, titled “Method and Apparatus for Processing Voice Request,” which is hereby incorporated by reference in its entirety.

### TECHNICAL FIELD

Embodiments of the present disclosure relate to the field of computer technology, specifically to the field of voice technology, and specifically to a method and apparatus for processing a voice request.

### BACKGROUND

A smart voice service refers to the voice service technology based on technologies such as the voice recognition technology and the voice synthesis technology. With the development of the artificial intelligence technology, the smart voice service is more and more widely applied to various scenarios.

In the smart voice service technology, generally access to a resource library maintained by the backend server of the smart voice service technology is supported. For example, a smart speaker is supported to play the music in the music resource library of a voice server. However, the resources in the resource library of the voice server are limited, and thus, it may be difficult for the voice server to provide a resource meeting the need of a user.

### SUMMARY

Embodiments of the present disclosure propose a method and apparatus for processing a voice request.

In a first aspect, the embodiments of the present disclosure provide a method for processing a voice request. The method includes: searching, in response to determining that a target multimedia resource requested to be played in a voice request is not included in a preset multimedia resource library, for the target multimedia resource in a resource library other than the multimedia resource library; and sending a link address of the found target multimedia resource and an instruction for playing the target multimedia resource to a smart voice device.

In some embodiments, searching for the target multimedia resource in the resource library other than the multimedia resource library includes: searching for the target multimedia resource in the resource library other than the multimedia resource library through a webpage. The sending a link address of the found target multimedia resource and an instruction for playing the target multimedia resource to a smart voice device includes sending the link address of the found target multimedia resource and the instruction for playing the target multimedia resource through the webpage to the smart voice device.

In some embodiments, before the searching, in response to determining that a target multimedia resource requested to be played in a voice request is not included in a preset multimedia resource library, for the target multimedia resource in a resource library other than the multimedia resource library, the method further includes: performing an intent analysis on the acquired voice request, to determine the target multimedia resource requested to be played in the voice request.

In some embodiments, the method further includes searching, in response to receiving a message informing that playing of the target multimedia resource in the webpage is completed, for a multimedia resource similar to the target multimedia resource, the message being sent by the smart voice device; and sending an instruction for playing the multimedia resource similar to the target multimedia resource to the smart voice device.

In some embodiments, after searching for the target multimedia resource in the webpage in response to determining that the target multimedia resource requested to be played in the voice request is not included in the preset multimedia resource library, the method further includes: setting a value of a preset play mode parameter to a parameter value for indicating a play mode being webpage play. The searching, in response to receiving a message informing that playing of the target multimedia resource in the webpage is completed, for a multimedia resource similar to the target multimedia resource, the message being sent by the smart voice device, includes: setting, in response to receiving the message informing that the playing of the target multimedia resource in the webpage is completed, the value of the preset play mode parameter to a parameter value for indicating the play mode being non-webpage play, the message being sent by the smart voice device; and searching, in response to determining that the value of the play mode parameter indicates a current play mode being the non-webpage play, for the multimedia resource similar to the target multimedia resource in the preset multimedia resource library.

In some embodiments, the method further includes: sending, in response to receiving a voice request for changing a play state of the target multimedia resource, an instruction for changing the play state of the target multimedia resource in the webpage to the smart voice device.

in a second aspect, the embodiments of the present disclosure provide an apparatus for processing a voice request. The apparatus includes: a searching unit, configured to search, in response to determining that a target multimedia resource requested to be played in a voice request is not included in a preset multimedia resource library, for the target multimedia resource in a resource library other than the multimedia resource library; and a sending unit, configured to send a link address of the found target multimedia resource and an instruction for playing the target multimedia resource to a smart voice device.

In some embodiments, the searching unit is further configured to: search, in response to determining that the target multimedia resource requested to be played in the voice request is not included in the preset multimedia resource library, for the target multimedia resource in the resource library other than the multimedia resource library through a webpage. The sending unit is further configured to: send the link address of the found target multimedia resource and an instruction for playing the target multimedia resource through the webpage to the smart voice device.

In some embodiments, the apparatus further includes an analyzing unit. The analyzing unit is configured to: perform an intent analysis on the acquired voice request to determine the target multimedia resource requested to be played in the voice request, before searching for the target multimedia resource in the resource library other than the multimedia resource library in response to determining that the target multimedia resource requested to be played in the voice request is not included in the preset multimedia resource library.

In some embodiments, the apparatus further includes a recommending unit. The recommending unit is configured to: search, in response to receiving a message informing that playing of the target multimedia resource in the webpage is completed, for a multimedia resource similar to the target multimedia resource, the message being sent by the smart voice device; and send an instruction for playing the multimedia resource similar to the target multimedia resource to the smart voice device.

In some embodiments, the apparatus further includes a setting unit. The setting unit is configured to set a value of a preset play mode parameter to a parameter value for indicating a play mode being webpage play, after searching for the target multimedia resource in the webpage in response to determining that the target multimedia resource requested to be played in the voice request is not included in the preset multimedia resource library. The recommending unit is further configured to: set, in response to receiving the message informing that the playing of the target multimedia resource in the webpage is completed, the value of the preset play mode parameter to a parameter value for indicating the play mode being non-webpage play, the message being sent by the smart voice device; and search, in response to determining the value of the play mode parameter indicating a current play mode being the non-webpage play, for the multimedia resource similar to the target multimedia resource in the preset multimedia resource library.

In some embodiments, the apparatus further includes a changing unit. The changing unit is configured to: send, in response to receiving a voice request for changing a play state of the target multimedia resource, an instruction for changing the play state of the target multimedia resource in the webpage to the smart voice device.

In a third aspect, the embodiments of the present disclosure provide an electronic device. The electronic device includes: one or more processors; and a storage device, configured to store one or more programs. The one or more programs, when executed by the one or more processors, cause the one or more processors to implement the method for processing a voice request provided in the first aspect.

In a fourth aspect, the embodiments of the present disclosure provide a computer readable storage medium storing a computer program. The program, when executed by a processor, implements the method for processing a voice request provided in the first aspect.

According to the method and apparatus for processing a voice request provided by the embodiments of the present disclosure, in response to determining that the target multimedia resource requested to be played in the voice request is not included in the preset multimedia resource library, a search for the target multimedia resource is performed in the webpage, and the link address of the found target multimedia resource and the instruction for playing the target multimedia resource through the webpage are sent to the smart voice device. Thus, the coverage of the content of a voice service is expanded, which can improve the efficiency of the voice service.

### BRIEF DESCRIPTION OF THE DRAWINGS

After reading detailed descriptions of non-limiting embodiments given with reference to the following accompanying drawings, other features, objectives and advantages of the present disclosure will be more apparent:

FIG. 1 is a diagram of an exemplary system architecture in which an embodiment of the present disclosure may be applied;

FIG. 2 is a flowchart of an embodiment of a method for processing a voice request according to the present disclosure;

FIG. 3 is a flowchart of another embodiment of the method for processing a voice request according to the present disclosure;

FIG. 4 is a flowchart of still another embodiment of the method for processing a voice request according to the present disclosure;

FIG. 5 is a schematic structural diagram of an apparatus for processing a voice request according to the present disclosure; and

FIG. 6 is a schematic structural diagram of a computer system adapted to implement an electronic device according to the embodiments of the present disclosure.

### DETAILED DESCRIPTION OF EMBODIMENTS

The present disclosure will be described below in detail with reference to the accompanying drawings and in combination with the embodiments. It should be appreciated that the specific embodiments described herein are merely used for explaining the relevant invention, rather than limit ng the invention. In addition, it should be noted that, for the ease of description, only the parts related to the relevant invention are shown in the accompanying drawings.

It should also be noted that the embodiments in the present disclosure and the features in the embodiments may be combined with each other on a non-conflict basis. The present disclosure will be described below in detail with reference to the accompanying drawings and in combination with the embodiments.

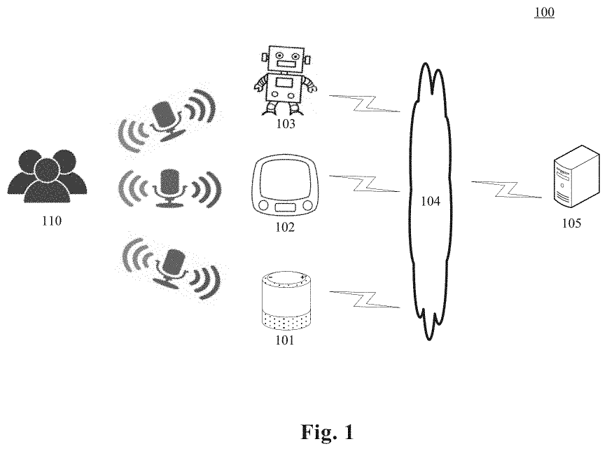

FIG. 1 shows an exemplary system architecture 100 in which a method for processing a voice request or an apparatus for processing a voice request according to the present disclosure may be applied.

As shown in FIG. 1, the system architecture 100 may include smart voice devices 101, 102 and 103, a network 104, and a server 105. The network 104 serves as a medium providing a communication link between the smart voice devices 101, 102 and 103 and the server 105. The network 104 may include various types of connections, for example, wired or wireless communication links, or optical fiber cables.

A user 110 may interact with the server 105 via the network 104 using the smart voice devices 101, 102 and 103, to receive or send messages. The smart voice devices 101, 102 and 103 may be various electronic devices having a microphone and a speaker and supporting a direct interaction with the user and the server 105, for example, smart robots, smart sound boxes, smart televisions and smart refrigerators. The smart voice devices 101, 102 and 103 may further have a display screen.

The server 105 may be a voice server providing a voice service. The voice server 105 may analyze a voice request sent by the smart voice devices 101, 102 and 103, find data according to the analysis result, and generate voice response information, and may feed back the voice response information to the smart voice devices 101, 102 and 103.

It should be noted that the method for processing a voice request provided by the embodiments of the present disclosure may be performed by the server 105. Correspondingly, the apparatus for processing a voice request may be provided in the server 105.

It should be noted that the server 105 may be hardware or software. When being the hardware, the server 105 may be implemented as a distributed server cluster composed of a plurality of servers, or as a single server. When being the software, the server 105 may be implemented as a plurality of pieces of software or a plurality of software modules (e.g., software or software modules for providing a distributed service), or as a single piece of software or a single software module, which will not be specifically defined here.

It should be appreciated that the numbers of the terminal devices, the networks, and the servers in FIG. 1 are merely illustrative. Any number of terminal devices, networks, and servers may be provided based on actual requirements.

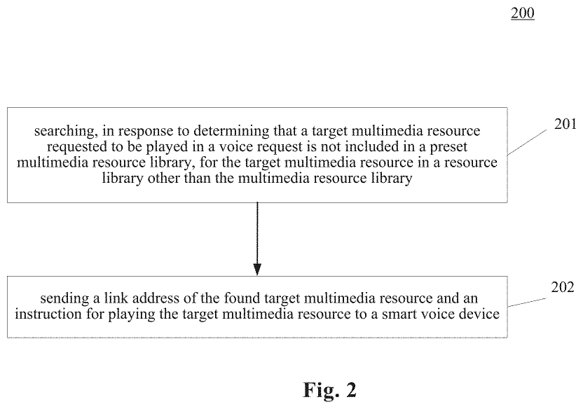

Further referring to FIG. 2, FIG. 2 illustrates a flow 200 of an embodiment of a method for processing a voice request according to the present disclosure. The method for processing a voice request includes the following steps 201 and 202.

Step 201 includes searching, in response to determining that a target multimedia resource requested to be played in a voice request is not included in a preset multimedia resource library, for the target multimedia resource in a resource library other than the multimedia resource library.

In this embodiment, an executing body (e.g., the server shown in FIG. 1) of the method for processing a voice request may receive the voice request, and extract related information in the voice request, the related information being used for indicating the target multimedia resource requested to be played. For example, the executing body may extract the information of the target multimedia resource such as the resource identifier, the type identifier and the creator identifier. Then, the executing body may search for the target multimedia resource in the preset multimedia resource library based on the extracted related information. Here, the preset multimedia resource library may be a multimedia resource library maintained by the executing body, and may include multimedia resource libraries of various data formats, for example, an image resource library, a video resource library and an audio resource library.

According to the extracted related information for indicating the target multimedia resource requested to be played in the voice request, the executing body may perform the search to determine whether the target multimedia resource is included in the preset multimedia resource library. Specifically, the related information of the target multimedia resource may be matched with the related information of each preset multimedia resource in the preset multimedia resource library, and the successfully matched preset multimedia resource is used as the search result of the target multimedia resource. If a multimedia resource having related information matching the related information used for indicating the target multimedia resource requested to be played and extracted from the voice request is not found in the preset multimedia resource library, it may be determined that the target multimedia resource is not included in the preset multimedia resource library.

When it is determined that the target multimedia resource is not included in the preset multimedia resource library, the search for the target multimedia resource may be performed in other resource libraries other than the preset multimedia resource library. Here, the other resource libraries other than the preset multimedia resource library may be multimedia resource libraries maintained by the server of a multimedia playing platform, for example, the multimedia resource libraries maintained by various pieces of video playing software or various pieces of music playing software.

In some embodiments, the searching for the target multimedia resource in a resource library other than the multimedia resource library may include: searching for the target multimedia resource in the resource library other than the multimedia resource library through a webpage. The executing body may search for the target multimedia resource in the webpage through a webpage browser. Specifically, a search condition may be generated according to the related information of the target multimedia resource extracted from the voice request. The search is initiated in the webpage, and a multimedia resource satisfying the related information is searched for using a search engine. The multimedia resource satisfying the related information and being found from the webpage may be used as the found target multimedia resource, the related information indicating the target multimedia resource and being extracted from the voice request.

In an actual scenario, a user may send a request for playing a multimedia resource to a smart voice device (e.g., a smart speaker). For example, the user may send the request “playing a song of Chinese rock style” or “I want to listen to the theme song of Titanic.” The smart speaker may forward the request to a voice server, and the voice server may extract “Chinese rock” for representing the style information of the musical track requested to be played, or extract “Titanic” for representing the name information of the album of the musical track. Then, the smart speaker may search to determine whether a corresponding musical track is included in the music library of the voice server. When the corresponding musical track is not found in the music library of the voice server, a search for the corresponding musical track may be performed by searching for “songs of Chinese rock style” or “the theme song of Titanic” in the webpage.

In some alternative implementations of this embodiment, before step 201, the method for processing a voice request may further include: performing an intent analysis on the acquired voice request, to determine the target multimedia resource requested to be played in the voice request. Specifically, the voice request sent by the user may be acquired through the smart voice device, and the voice request is converted into the corresponding text using a voice recognition technology. Then, a semantic analysis may be performed on the text corresponding to the voice request using a natural language processing technology. For example, a keyword is extracted using a keyword extraction method that is based on a keyword dictionary, to find semantics corresponding to the keyword, or to input the text corresponding to the voice request into a trained semantic analysis machine learning model to obtain a semantic analysis result, and thus, the intent of the user sending the voice request is acquired. Alternatively, matching may be performed with the text corresponding to the voice request based on a multimedia resource attribute information base including attribute information of multimedia resources, to extract a keyword matching multimedia resource attribute information, and use the multimedia resource corresponding to the multimedia resource attribute information matching the keyword in the text corresponding to the voice request as the target multimedia resource. Here, the multimedia resource attribute information base may be obtained based on statistics on attribute information of a large number of multimedia resources, and may include names of a plurality of creators, names of a plurality of albums, tags of a plurality of styles and values of a plurality of playing heat levels, etc.

Step 202 includes sending a link address of the FOUND target multimedia resource and an instruction for playing the target multimedia resource to a smart voice device.

After the target multimedia resource is found in the webpage, the link address of the target multimedia resource may be sent to the smart voice device sending the voice request to the executing body. At the same time, the executing body may send the instruction for playing the target multimedia resource to the smart voice device. The instruction for playing the target multimedia resource may include a command to trigger a playing operation, and when the command is executed, the received link address of the target multimedia resource is called.

In some embodiments, if the searching for the target multimedia resource in the resource library other than the multimedia resource library in step 201 is achieved by searching for multimedia resource in the resource library other than the multimedia resource library through the webpage, the link address of the found target multimedia resource and the instruction for playing the target multimedia resource through the webpage may be sent to the smart voice device in step 202.

The instruction for playing the target multimedia resource through the webpage may include a JavaScript command for playing the target multimedia resource. After receiving the JavaScript command for playing the target multimedia resource, the smart voice device may analyze the command and start a webpage browser, to inject the code of the JavaScript command sent by the executing body, and load the link address of the target multimedia content through the tag “<audio>.” That is, the URL (uniform resource locator) of the target multimedia content is loaded in the tag “<audio>” to play the target multimedia content.

In some alternative implementations of the embodiment, the smart voice device may be pre-deployed with a module for implementing the playing of a webpage multimedia resource, and the module includes a logic code for implementing the playing of the webpage multimedia resource. When receiving the instruction for playing the target multimedia resource through the webpage, the smart voice device may run the corresponding logic code in the module for implementing the playing of the webpage multimedia resource, to implement the playing of the webpage multimedia resource at the side of the smart voice device.

In other alternative implementations of the embodiment, the instruction for playing the target multimedia resource through the webpage, which is sent to the smart voice device by the executing body, may include the JavaScript code for implementing a logic of controlling the playing of a HTML5 (Hyper Text Markup Language 5) webpage. When receiving the instruction for playing the target multimedia resource through the webpage, the smart voice device may open the HTML5 webpage and inject the received JavaScript code for implementing the logic of controlling the playing of the HTML5 webpage, to control the tag “<audio>” under the HTML5 page, thus implementing the playing of the multimedia resource.

According to the method for processing a voice request of the foregoing embodiment of the present disclosure, in response to determining the target multimedia resource requested to be played in a voice request being not included in the preset multimedia resource library, the search for the target multimedia resource is performed in the resource library other than the multimedia resource library, and the link address of the found target multimedia resource and the instruction for playing the target multimedia resource are sent to the smart voice device, which can expand the coverage of the content provided by a voice service, thereby improving the efficiency of the voice service.

In addition, in some alternative implementations of the foregoing embodiment, a search for the target multimedia link is performed in the webpage, and the instruction for playing the target multimedia resource through the webpage is sent to the smart voice device, which can implement the control on the playing of the webpage multimedia resource that is based on the voice, thereby implementing the resource access to rich resource in the voice service, which can expand the coverage of the content the voice service and the ways of the voice service by effectively using the webpage multimedia resource, and thus the efficiency of the voice service may be improved.

In some alternative implementations of this embodiment, voice response information may alternatively be generated based on the attribute information of the searched target multimedia resource. The attribute information of the multimedia resource may include the creator of the multimedia resource, the name of the album of the multimedia resource, the publisher of the multimedia resource, and the like. Based on a pre-configured conversation template, the attribute information of the multimedia may be added to a corresponding slot of the conversation template, and converted into corresponding voice response information by voice synthesis. For example, when the voice request of the user is “I want to listen to the theme song of Titanic,” the voice response information “‘the theme song of Titanic’ is found in ‘XX Music,’ and plays for you” may be generated. Here, “‘XX Music’” and “‘the theme song of Titanic’” are the contents added into the corresponding slot of the conversation template.

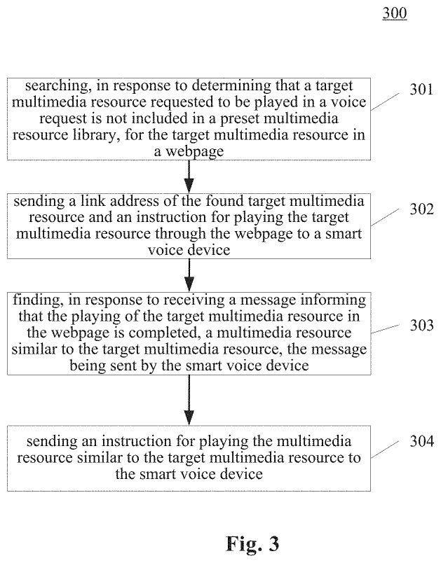

Further referring to FIG. 3, FIG. 3 is a flowchart of another embodiment of the method for processing a voice request according to the present disclosure. As shown in FIG. 3, the flow 300 of the method for processing a voice request in this embodiment includes the following steps 301 to 304.

Step 301 includes searching, in response to determining that a target multimedia resource requested to be played in a voice request is not included in a preset multimedia resource library, for the target multimedia resource in a webpage.

In this embodiment, an executing body (e.g., the server shown in FIG. 1) of the method for processing a voice request may receive the voice request, and extract related information in the voice request, the related information being used for indicating the target multimedia resource requested to be played. In the preset multimedia resource library, the executing body queries whether the target multimedia resource is included, with the related information as a query condition. Here, the preset multimedia resource library may be a multimedia resource library maintained by the executing body. If the target multimedia resource is not found in the preset multimedia resource library, the webpage may be opened. The related information for indicating the target multimedia resource requested to be played in the voice request is used as a search condition, and thus, a search for the target multimedia resource is performed through the webpage.

In some alternative implementations of this embodiment, before step 301, an intent analysis may be performed on the acquired voice request, to determine the target multimedia resource requested to be played in the voice request. Specifically, after the voice request, sent by a smart voice device is acquired, the voice is converted into a text using a voice recognition technology. Then, an intent recognition based on a keyword or an intent recognition model may be performed on the text, to determine the related information of the target multimedia resource requested to be played in the voice request, for example, the identifier, the style and type, and the creator of the target multimedia resource.

Step 302 includes sending a link address of the found target multimedia resource and an instruction for playing the target multimedia resource through the webpage to a smart voice device.

After the target multimedia resource is found in the webpage, the link address of the target multimedia resource may be sent to the smart voice device sending the voice request to the executing body. At the same time, the executing body may send the instruction for playing the target multimedia resource through the webpage to the smart voice device. The instruction for playing the target multimedia resource through the webpage may include a JavaScript command to play the target multimedia resource. After receiving the JavaScript command to play the target multimedia resource, the smart voice device may analyze the command and start a webpage browser, to inject the code of the JavaScript command sent by the executing body, and load the link address of the target multimedia content through the tag “<audio>,” to play the target multimedia content.

The steps 301 and 302 in this embodiment are respectively consistent with the steps 201 and 202 in the foregoing embodiment. For the specific implementations of the steps 301 and 302, reference may be made to the related descriptions of the steps 201 and 202.

Step 303 includes finding, in response to receiving a message informing that the playing of the target multimedia resource in the webpage is completed, a multimedia resource similar to the target multimedia resource, the message being sent by the smart voice device.

In this embodiment, after playing the target multimedia resource found through the webpage, the smart voice device may report the message informing that the playing is completed to the executing body. Alter receiving the message informing that the playing of the target multimedia resource in the webpage is completed, which is reported by the smart voice device, the executing body may find the content similar to the target multimedia resource.

Specifically, a multimedia resource may be pre-configured with a content tag representing an attribute feature of the multimedia resource, and the content tag may include, but not limited to, a creator tag, a style tag, a name tag, a creation time tag, a title tag, and the like. When finding the multimedia resource similar to the target multimedia resource, the executing body may find the multimedia resource having a content tag identical or similar to a content tag of the target multimedia resource. The executing body may alternatively perform a feature extraction on the content of the multimedia resource to obtain a feature of the multimedia resource, and then find the multimedia resource similar to the target multimedia resource based on a similarity between the features of multimedia resources.

In some alternative implementations of this embodiment, in response to receiving the message informing that the playing of the target multimedia resource in the webpage is completed, the message being sent by the smart voice device, the executing body may find the multimedia resource similar to the target multimedia resource in the preset multimedia resource library. In other alternative implementations of this embodiment, in response to receiving the message informing that the playing of the target multimedia resource in the webpage is completed, the message being sent by the smart voice device, the executing body may find the multimedia resource similar to the target multimedia resource through the webpage.

In some alternative implementations of this embodiment, the executing body may save a preset play mode parameter. The preset play mode parameter is used to represent that the current play mode is webpage play or non-webpage play. After step 301, the flow 300 of the method for processing a voice request may further include: setting a value of the preset play mode parameter to a parameter value for indicating the play mode being the webpage play. Then, in step 303, the executing body may set the value of the play mode parameter to a parameter value for indicating the play mode being the non-webpage play in response to receiving the message informing that the playing of the target multimedia resource in the webpage is completed, the message being sent by the smart voice device, and may find the multimedia resource similar to the target multimedia resource in the preset multimedia resource library in response to determining that the value of the play mode parameter indicates the current play mode being the non-webpage play. That is, before the multimedia resource similar to the target multimedia resource is found, whether the play mode parameter indicates that the current play mode is the non-webpage play is determined according to the value of the preset play mode parameter. If the play mode parameter indicates that the current play mode is the non-webpage play, the similar multimedia resource may be found in the preset multimedia resource library.

In an exemplary scenario, after the playing of the music played through the webpage ends, the smart voice device may send a notification message to a voice server to inform the voice server that the playing of the current music ends. At this point, a voice service may modify the value of the play mode parameter, so that the play mode parameter indicates that the current play mode is the non-webpage play. Thus, the voice server may find music similar to the music played through the webpage in a music resource library maintained by the voice server itself.

Step 304 includes sending an instruction for playing the multimedia resource similar to the target multimedia resource to the smart voice device.

After the multimedia resource similar to the target multimedia resource is found, the instruction for playing the multimedia resource similar to the target multimedia resource may be sent to the smart voice device. At the same time, the found multimedia resource similar to the target multimedia resource may be sent to the smart voice device to be played by the smart voice device.

In some alternative implementations of this embodiment, according to a pre-configured music recommendation conversation template, the executing body may further send voice information for informing the user that the multimedia resource similar to the target multimedia resource is to be played to the smart voice device. For example, the executing body may send the voice information “the following good music is also recommended to you” to the smart voice device, and the smart voice device may output the voice information.

As may be seen from FIG. 3, in this embodiment, the similar multimedia resource is found after the playing of the webpage multimedia resource ends, and a responding playing instruction is sent to the smart voice device, to provide the user with the multimedia resource that the user may be interested in, thus further improving the efficiency of the voice service.

Referring to FIG. 4, FIG. 4 is a flowchart of still another embodiment of the method for processing a voice request according to the present disclosure. As shown in FIG. 4, the flow 400 of the method for processing a voice request in this embodiment may include the following steps 401 to 403.

Step 401 includes searching, in response to determining that a target multimedia resource requested to be played in a voice request is not included in a preset multimedia resource library, for the target multimedia resource in a webpage.

In this embodiment, an executing body (e.g., the server shown in FIG. 1) of the method for processing a voice request may receive the voice request, and extract related information in the voice request, the related information being used for indicating the target multimedia resource requested to be played. In the preset multimedia resource library, the executing body queries whether the target multimedia resource is included, with the related information as a query condition. Here, the preset multimedia resource library may be a multimedia resource library maintained by the executing body. If the target multimedia resource is not found in the preset multimedia resource library, the webpage may be opened. The related information for indicating the target multimedia resource requested to be played in the voice request is used as a search condition, and thus, the target multimedia resource is searched through the webpage.

In some alternative implementations of this embodiment, before step 401, an intent analysis may further be performed on the acquired voice request, to determine the target multimedia resource requested to be played in the voice request. Specifically, after the voice request sent by a smart voice device is acquired, the voice is converted into a text using a voice recognition technology. Then, an intent recognition based on a keyword or an intent recognition model may be performed on the text, to determine the related information of the target multimedia resource requested to be played in the voice request, for example, the identifier, the style and type, and the creator of the target multimedia resource.

Step 402 includes sending a link address of the found target multimedia resource and an instruction for playing the target multimedia resource through the webpage to a smart voice device.

After the target multimedia resource is found in the webpage, the link address of the target multimedia resource may be sent to the smart voice device sending the voice request to the executing body. At the same time, the executing body may send the instruction for playing the target multimedia resource through the webpage to the smart voice device. The instruction for playing the target multimedia resource through the webpage may include a JavaScript command to play the target multimedia resource. After receiving the JavaScript command to play the target multimedia resource, the smart voice device may analyze the command and start a webpage browser, to inject the code of the JavaScript command sent by the executing body, and load the link address of the target multimedia content through the tag “<audio>,” to play the target multimedia content.

The steps 401 and 402 in this embodiment are respectively consistent with the steps 201 and 202 in the foregoing embodiment. For the specific implementations of the steps 401 and 402, reference may be made to the related descriptions of the steps 201 and 202.

Step 403 includes sending, in response to receiving a voice request to change a play state of the target multimedia resource, an instruction for changing the play state of the target multimedia resource in the webpage to the smart voice device.

In this embodiment, the playing of the target multimedia resource through the webpage may be controlled. Specifically, when the target multimedia resource is played through the webpage, the voice request for changing the play state may be received, where the voice request is sent through the smart voice device by a user. Then, according to the request, the corresponding instruction for changing the play state of the target multimedia resource in the webpage is generated and sent to the smart voice device. Here, the voice request for changing the play state may refer to a request for switching the current play state to another play state. The changing of the play state may include, but not limited to, pausing playing, continuing the playing, exiting the playing, playing a next track, playing a previous track, and the like.

The executing body may analyze the voice request received during the playing of the target multimedia resource through the webpage, and determine whether the user sending the voice request has an intent to change the play state. For example, the voice request may be converter into a text message, and then analyzed using a natural language processing technology to obtain the intent of the user. When it is obtained that the intent of the user is to change the current play state, a corresponding instruction for performing a play state changing operation in the webpage may be generated according to the intent of the user. For example, a JavaScript instruction for changing the play state is generated and sent to the smart voice device. The smart voice device may perform the play state changing operation by loading the received instruction in the webpage.

Alternatively, the voice request for changing the play state of the target multimedia resource may be a voice request to play the next track. At this point, the executing body may recognize that the intent of the user is to switch to the next track to play. Then, the executing body may find the multimedia resource similar to the target multimedia resource, and push the multimedia resource to the smart voice device to play the multimedia resource. Alternatively, the executing body may further set the value of the preset play mode parameter to a parameter value for indicating that the play mode is none-webpage play, and then find the multimedia resource similar to the target multimedia resource in the preset multimedia resource library.

Alternatively, the voice request for changing the play state of the target multimedia resource may be a voice request for pausing/continuing the playing. When recognizing that the intent of the user is to pause or continue the playing according to the voice request, the executing body may detect whether the current play state is the webpage play state. If the current play state is the webpage play state, the executing body may send an instruction for pausing/continuing playing the target multimedia resource through the webpage to the smart voice device. The instruction may be, for example, a JavaScript instruction. After receiving the JavaScript instruction, the smart voice device may inject rendering to the JavaScript instruction in the webpage, to control the tag “<Audio>” to perform the operation of pausing or continuing the playing.

Alternatively, the voice request for changing the play state of the target multimedia resource may be a voice request for exiting the playing of the multimedia resource. When recognizing that the intent of the user is to exit the playing of the multimedia resource according to the voice request, the executing body may detect whether the current play state is the webpage play state. If the current play state is the webpage play state, the executing body may send an exit instruction to the smart voice device. The exit instruction may instruct to close the webpage opened by the smart voice device. After receiving the exit instruction, the smart voice device may close the webpage and exit the web browser.

In some alternative implementations of this embodiment, after playing the target multimedia resource, the smart voice device may report the notification message. Then, in response to receiving a message informing that the playing of the target multimedia resource in the webpage is completed, the message being sent by the smart voice device, the executing body may search for the multimedia resource similar to the target multimedia resource in the preset multimedia resource library or in the webpage, and send an instruction for playing the multimedia resource similar to the target multimedia resource to the smart voice device.

Further, after step 401, the executing body may further set the value of the preset play mode parameter to the parameter value for indicating that the play mode is webpage play. In this case, the executing body may set the value of the play mode parameter to a parameter value indicating that the play mode is non-webpage play, in response to receiving the message informing that the playing of the target multimedia resource in the webpage is completed, which is sent by the smart voice device. The executing body may search for the multimedia resource similar to the target multimedia resource in the preset multimedia resource library, in response to determining that the value of the play mode parameter indicates a current play mode being the non-webpage play. That is, after receiving the message informing that the playing of the target multimedia resource is completed, the executing body may set the value of the play mode parameter to the parameter value indicating that the play mode is the non-webpage play. As such, the multimedia resource similar to the target multimedia resource is found in the preset multimedia resource library to be recommended and played. In this way, multimedia resources that the user are interested in may be quickly provided using the preset multimedia resource library, thereby improving the efficiency of the voice service.

As may be seen from FIG. 4, according to the method for a voice request in this embodiment, when the voice request for changing the play state of the target multimedia resource is received, the instruction for changing the play state of the target multimedia resource in the webpage is sent to the smart voice device. Therefore, the control of the playing of the multimedia resource through the webpage based on the voice request is achieved, thus improving the flexibility of the control over the playing of the multimedia resource.

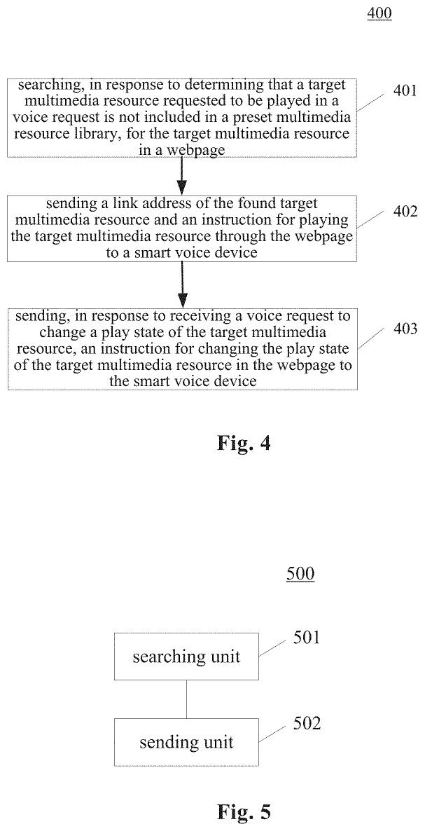

Further referring to FIG. 5, as an implementation of the method shown in the above drawings, the present disclosure provides an embodiment of an apparatus for processing a voice request. The embodiment of the apparatus corresponds to the embodiments of the method shown in FIGS. 2, 3 and 4, and the apparatus may be applied in various electronic devices.

As shown in FIG. 5, the apparatus 500 for processing a voice request in this embodiment may include: a searching unit 501 and a sending unit 502. Here, the searching unit 501 may be configured to search, in response to determining that a target multimedia resource requested to be played in a voice request is not included in a preset multimedia resource library, for the target multimedia resource in a resource library other than the multimedia resource library. The sending unit 502 may be configured to send a link address of the found target multimedia resource and an instruction for playing the target multimedia resource to a smart voice device.

In some embodiments, the searching unit 501 may be further configured to: search, in response to determining that the target multimedia resource requested to be played in the voice request is not included in the preset multimedia resource library, for the target multimedia resource in the resource library other than the multimedia resource library through a webpage. The sending unit 502 may be further configured to: send the link address of the found target multimedia resource and an instruction for playing the target multimedia resource through the webpage to the smart voice device.

In some embodiments, the apparatus 500 may further include an analyzing unit. The analyzing unit is configured to: perform an intent analysis on the acquired voice request to determine the target multimedia resource requested to be played in the voice request, before the search for the target multimedia resource is performed in the resource library other than the multimedia resource library in response to determining that the target multimedia resource requested to be played in the voice request is not included in the preset multimedia resource library.

In some embodiments, the apparatus 500 may further include a recommending unit. The recommending unit is configured to: search, in response to receiving a message informing that playing of the target multimedia resource in the webpage is completed, a multimedia resource similar to the target multimedia resource, the message being sent by the smart voice device; and send an instruction for playing the multimedia resource similar to the target multimedia resource to the smart voice device.

In some embodiments, the apparatus 500 may further include a setting unit. The setting unit is configured to set a value of a preset play mode parameter to a parameter value for indicating a play mode being webpage play, after the search for the target multimedia resource is performed in the webpage in response to determining that the target multimedia resource requested to be played in the voice request is not included in the preset multimedia resource library. The recommending unit is further configured to: set, in response to receiving the message informing that the playing of the target multimedia resource in the webpage is completed, which is sent by the smart voice device, the value of the preset play mode parameter to a parameter value for indicating the play mode being non-webpage play; and find, in response to determining the value of the play mode parameter indicating a current play mode being the non-webpage play, the multimedia resource similar to the target multimedia resource in the preset multimedia resource library.

In some embodiments, the apparatus 500 may further include a changing unit. The changing unit is configured to: send, in response to receiving a voice request for changing a play state of the target multimedia resource, an instruction for changing the play state of the target multimedia resource in the webpage to the smart voice device.

It should be understood that the units recited in the apparatus 500 correspond to the steps in the method described with reference to FIGS. 2, 3 and 4. Thus, the operations and features described above for the method are also applicable to the apparatus 500 and the units included therein, which will not be repeatedly described here.

According to the apparatus 500 for processing a voice request provided by the above embodiment of the present disclosure, in response to determining that the target multimedia resource requested to be played in the voice request is not included in the preset multimedia resource library, the search for the target multimedia resource is performed in the resource library other than the multimedia resource library, and the link address of the found target multimedia resource and the instruction for playing the target multimedia resource are sent to the smart voice device. Therefore, the coverage of the content of a voice service is expanded, thus improving the efficiency of the voice service.

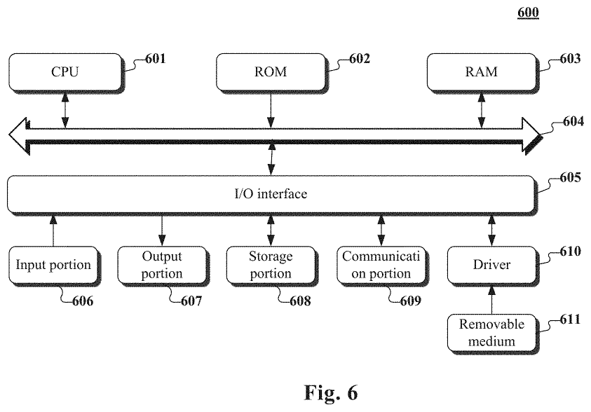

Referring to FIG. 6, FIG. 6 is a schematic structural diagram of a computer system 600 adapted to implement an electronic device of the embodiments of the present disclosure. The electronic device shown in FIG. 6 is merely an example, and should not bring any limitations to the functions and the scope of use of the embodiments of the present disclosure.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse, a microphone, etc.; an output portion 607 including a cathode ray tube (CRT), a liquid crystal display device (LCD), a speaker etc.; a storage portion 608 including a hard disk and the like; and a communication portion 609 including a network interface card such as a LAN (local area network) card and a modem. The communication portion 609 performs communication processes via a network such as the Internet. A driver 610 is also connected to the I/O interface 605 as required. A removable medium 611 such as a magnetic disk, an optical disk, a magneto-optical disk, and a semiconductor memory may be installed on the driver 610, to facilitate the retrieval of a computer program from the removable medium 611, and the installation thereof on the storage portion 608 as needed.

In particular, according to embodiments of the present disclosure, the process described above with reference to the flow chart may be implemented as a computer software program. For example, an embodiment of the present disclosure includes a computer program product, including a computer program hosted on a computer readable medium, the computer program including program codes for performing the method as illustrated in the flowchart. In such an embodiment, the computer program may be downloaded and installed from a network via the communication portion 609, and/or may be installed from the removable medium 611. The computer program, when executed by the central processing unit (CPU) 601, implements the above mentioned functionalities defined in the method of the present disclosure. It should be noted that the computer readable medium in the present disclosure may be a computer readable signal medium, a computer readable storage medium, or any combination of the two. For example, the computer readable storage medium may be, but not limited to: an electronic, magnetic, optical, electromagnetic, infrared, or semiconductor system, apparatus, or element, or any combination of the above. A more specific example of the computer readable storage medium may include, but not limited to: an electrical connection having one or more wires, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs, which may be used by a command execution system, apparatus or element or incorporated thereto. In the present disclosure, the computer readable signal medium may include a data signal that is propagated in a baseband or as a part of a carrier wave, which carries computer readable program codes. Such propagated data signal may be in various forms, including, but not limited to, an electromagnetic signal, an optical signal, or any suitable combination of the above. The computer readable signal medium may also be any computer readable medium other than the computer readable storage medium. The computer readable medium is capable of transmitting, propagating or transferring programs for use by, or used in combination with, a command execution system, apparatus or element. The program codes contained on the computer readable medium may be transmitted with any suitable medium including, but not limited to, wireless, wired, optical cable, RF medium, or any suitable combination of the above.

A computer program code for executing the operations according to the present disclosure may be written in one or more programming languages or a combination thereof. The programming language includes an object-oriented programming language such as Java, Smalltalk and C++, and further includes a general procedural programming language such as “C” language or a similar programming language. The program codes may be executed entirely on a user computer, executed partially on the user computer, executed as a standalone package, executed partially on the user computer and partially on a remote computer, or executed entirely on the remote computer or a server. When the remote computer is involved, the remote computer may be connected to the user computer through any type of network, including a local area network (LAN) or a wide area network (WAN), or be connected to an external computer (e.g., connected through Internet provided by an Internet service provider).

The flowcharts and block diagrams in the accompanying drawings illustrate architectures, functions and operations that may be implemented according to the system, the method, and the computer program product of the various embodiments of the present disclosure. In this regard, each of the blocks in the flowcharts or block diagrams may represent a module, a program segment, or a code portion, the module, the program segment, or the code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be executed in a reverse sequence, depending on the function involved. It should also be noted that each block in the block diagrams and/or flowcharts as well as a combination of blocks may be implemented using a dedicated hardware-based system executing specified functions or operations, or by a combination of dedicated hardware and computer instructions.

The units involved in the embodiments of the present disclosure may be implemented by means of software or hardware. The described units may also be provided in a processor. For example, the processor may be described as: a processor comprising a searching unit and a sending unit. The names of these units do not in some cases constitute a limitation to such units themselves. For example, the searching unit may alternatively be described as “a unit for searching, in response to determining that a target multimedia resource requested to be played in a voice request is not included in a preset multimedia resource library, the target multimedia resource in a webpage.”

In another aspect, the present disclosure further provides a computer readable medium. The computer readable medium may be the computer readable medium included in the apparatus described in the above embodiments, or a stand-alone computer readable medium not assembled into the apparatus. The computer readable medium carries one or more programs. The one or more programs, when executed by the apparatus, cause the apparatus to: search, in response to determining that a target multimedia resource requested to be played in a voice request is not included in a preset multimedia resource library, the target multimedia resource in a resource library other than the multimedia resource library; and send a link address of the found target multimedia resource and an instruction for playing the target multimedia resource to a smart voice device.

The above description is only an explanation for the preferred embodiments of the present disclosure and the applied technical principles. It should be appreciated by those skilled in the art that the inventive scope of the present disclosure is not limited to the technical solution formed by the particular combinations of the above technical features. The inventive scope should also cover other technical solutions formed by any combinations of the above technical features or equivalent features thereof without departing from the concept of the invention, for example, technical solutions formed by replacing the features as disclosed in the present disclosure with (but not limited to) technical features with similar functions.

What is claimed is:

1. A method for processing a voice request, comprising:
searching, in response to determining that a target multimedia resource requested to be played in a voice request is not included in a preset multimedia resource library, for the target multimedia resource in a resource library other than the multimedia resource library; and
sending a link address of the found target multimedia resource and an instruction for playing the target multimedia resource to a smart voice device.

2. The method according to claim 1, wherein the searching for the target multimedia resource in the resource library other than the multimedia resource library comprises:
searching for the target multimedia resource in the resource library other than the multimedia resource library through a webpage, and
the sending a link address of the found target multimedia resource and an instruction for playing the target multimedia resource to a smart voice device comprises:
sending the link address of the found target multimedia resource and an instruction for playing the target multimedia resource through the webpage to the smart voice device.

3. The method according to claim 1, wherein, before the searching, in response to determining that a target multimedia resource requested to be played in a voice request is not included in a preset multimedia resource library, for the target multimedia resource in a resource library other than the multimedia resource library, the method further comprises:
performing an intent analysis on the acquired voice request, to determine the target multimedia resource requested to be played in the voice request.

4. The method according to claim 2, further comprising:
searching, in response to receiving a message informing that playing of the target multimedia resource in the webpage is completed, for a multimedia resource similar to the target multimedia resource, the message being sent by the smart voice device; and
sending an instruction for playing the multimedia resource similar to the target multimedia resource to the smart voice device.

5. The method according to claim 4, wherein, after searching for the target multimedia resource in the webpage in response to determining that the target multimedia resource requested to be played in the voice request is not included in the preset multimedia resource library, the method further comprises:
setting a value of a preset play mode parameter to a parameter value for indicating a play mode being webpage play, and
wherein the searching, in response to receiving a message informing that playing of the target multimedia resource in the webpage is completed, for a multimedia resource similar to the target multimedia resource, the message being sent by the smart voice device comprises:
setting, in response to receiving the message informing that the playing of the target multimedia resource in the webpage is completed, the value of the preset play mode parameter to a parameter value for indicating the play mode being non-webpage play, the message being sent by the smart voice device; and
searching, in response to determining the value of the play mode parameter indicating a current play mode being the non-webpage play, for the multimedia resource similar to the target multimedia resource in the preset multimedia resource library.

6. The method according to claim 2, further comprising:
sending, in response to receiving a voice request for changing a play state of the target multimedia resource, an instruction for changing the play state of the target multimedia resource in the webpage to the smart voice device.

7. An apparatus for processing a voice request, comprising:
at least one processor; and
a memory storing instructions, wherein the instructions when executed by the at least one processor, cause the at least one processor to perform operations, the operations comprising:
searching, in response to determining that a target multimedia resource requested to be played in a voice request is not included in a preset multimedia resource library, for the target multimedia resource in a resource library other than the multimedia resource library; and
sending a link address of the found target multimedia resource and an instruction for playing the target multimedia resource to a smart voice device.

8. The apparatus according to claim 7, wherein the searching for the target multimedia resource in the resource library other than the multimedia resource library comprises:
searching for the target multimedia resource in the resource library other than the multimedia resource library through a webpage, and
the sending a link address of the found target multimedia resource and an instruction for playing the target multimedia resource to a smart voice device comprises:
sending the link address of the found target multimedia resource and an instruct on for playing the target multimedia resource through the webpage to the smart voice device.

9. The apparatus according to claim 7, wherein the operations further comprise:
performing an intent analysis on the acquired voice request to determine the target multimedia resource requested to be played in the voice request, before searching for the target multimedia resource in the resource library other than the multimedia resource library in response to determining that the target multimedia resource requested to be played in the voice request is not included in the preset multimedia resource library.

10. The apparatus according to claim 8, wherein the operations further comprise:
searching, in response to receiving a message informing that playing of the target multimedia resource in the webpage is completed, for a multimedia resource similar to the target multimedia resource, the message being sent by the smart voice device; and
sending an instruction for playing the multimedia resource similar to the target multimedia resource to the smart voice device.

11. The apparatus according to claim 10, wherein the operations further comprise setting a value of a preset play mode parameter to a parameter value for indicating a play mode being webpage play, after searching for the target multimedia resource in the webpage in response to determining that the target multimedia resource requested to be played in the voice request is not included in the preset multimedia resource library, and
wherein the searching, in response to receiving a message informing that playing of the target multimedia resource in the webpage is completed, for a multimedia resource similar to the target multimedia resource, the message being sent by the smart voice device comprises:
setting, in response to receiving the message informing that the playing of the target multimedia resource in the webpage is completed, the value of the preset play mode parameter to a parameter value for indicating the play mode being not play, the message being sent by the smart voice device; and
searching, in response to determining the value of the play mode parameter indicating a current play mode being the non-webpage play, for the multimedia resource similar to the target multimedia resource in the preset multimedia resource library.

12. The apparatus according to claim 8, wherein the operations further comprise:
sending, in response to receiving a voice request for changing a play state of the target multimedia resource, an instruction for changing the play state of the target multimedia resource in the webpage to the smart voice device.

13. A non-transitory computer readable storage medium, storing a computer program, wherein the program, when executed by a processor, causes the processor to perform operations, the operations comprising:
searching, in response to determining that a target multimedia resource requested to be played in a voice request is not included in a preset multimedia resource library, for the target multimedia resource in a resource library other than the multimedia resource library; and
sending a link address of the found target multimedia resource and an instruction for playing the target multimedia resource to a smart voice device.
